(19) United States
(12) Patent Application Publication
(10) Pub. No.: US 2015/0254431 A1
(43) Pub. Date: Sep. 10, 2015

(54) PATIENT INFORMATION DELIVERY AND COLLECTION SYSTEM

(71) Applicant: Trifecta Medical Group, LLC, Woodbury, MN (US)

(72) Inventors: Robert Gaertner, North Oaks, MN (US); Kevin Hallman, Woodbury, MN (US); Pete Sershon, Eden Prairie, MN (US)

(21) Appl. No.: 14/640,365

(22) Filed: Mar. 6, 2015

Related U.S. Application Data
(60) Provisional application No. 61/949,470, filed on Mar. 7, 2014.
(60) Provisional application No. 61/949,220, filed on Mar. 6, 2014.

(51) Int. Cl. G06F 19/00

(52) U.S. Cl. CPC G06F 19/363; G06F 19/327

(57) ABSTRACT

A multi-level patient information delivery system and data collection application. More specifically, an enhanced patient communication and data collection system that functions for pre-, peri-, and post-operative settings. One component of the system is a modified patient portal designed to guide patients through specific surgical experiences by giving access to time-relevant and needs-specific information as the patient moves from pre-operative assessment through post-operative recovery. A second component of the system is a database collection and analysis program for the doctor, surgeon, or other attending physician.

### CROSS-REFERENCE TO RELATED APPLICATIONS

This application claims the benefit of U.S. Provisional Application No. 61/949,220, filed Mar. 6, 2014, titled PATIENT INFORMATION DELIVERY AND COLLECTION SYSTEM and U.S. Provisional Application No. 61/949,470, filed Mar. 7, 2014, titled PATIENT INFORMATION DELIVERY AND COLLECTION SYSTEM.

### FIELD OF THE DISCLOSURE

The disclosed invention relates to a method for managing patient information and communication. Additionally, the disclosed invention relates to data collection during a surgical operation.

### BACKGROUND

In independent physician practices, current perioperative patient communications often depend on paper pamphlets and folders. Most surgical procedure education is given through face-to-face discussion. It is typically supplemented with printed information and verbal encouragement to review ancillary information over the internet, sometimes through the physician group website. Patient compliance with pre- and post-operative instructions is hoped for and usually, though often erroneously, assumed.

Clinical database collection to review surgical results, if done at all, often involves inputting a disorganized selection of information resources into a spreadsheet. This is a laborious task that is rarely completed by physicians. Further, while many surgeons quote results from academic papers when discussing outcomes, they rarely know the outcomes of their partners or other surgeons in the region.

Current developing models in the healthcare market, such as Accountable Care Organizations (ACOs), will depend on, and will expect all participating physicians to be able to provide, clinical outcome, patient satisfaction, and probably cost data for their procedures. For any independent group practices attempting to create an individual system that fulfills these criteria, this data collection will be costly and labor intensive.

However, if physicians do not collect and control their own data, extrinsic database sources, often using inaccurate or poorly collected information, can and will be used to make decisions that may affect the viability of independent physician groups.

Additionally, current intra-operative data collection systems are incomplete, inconsistent, and often inaccurate. Access to operative team efficiency and performance data can be elusive, and even if it is available, surgeons may not have the time and energy needed to collect, extract, and analyze the information they need. These flawed data collection systems also make it difficult to assess and track any advances in technology or emerging changes in technique in a consistent, reproducible, and meaningful way.

### BRIEF SUMMARY OF THE INVENTION

The disclosed system and method is, generally, a multi-level patient information delivery system and data collection application. One component of the system is a modified patient portal designed to guide patients through specific surgical experiences. A second component of the system is a database collection and analysis program for the doctor, surgeon, or other attending physician.

### BRIEF DESCRIPTION OF THE DRAWINGS

FIG. 1 is an illustration of one example of a pre-surgery message.

FIG. 2 is an illustration of one example of a patient login page.

FIG. 3 is an illustration of one example of a pre-surgery web page.

FIG. 4 is an illustration of one example of a pre-surgery web page.

FIG. 5 is an illustration of one example of a post-surgery message.

FIG. 6 is an illustration of one example of a post-surgery survey web page.

FIG. 7 is an illustration of one example of a post-surgery resource web page.

FIG. 8 is an illustration of one example of a physician login page.

FIG. 9 is an illustration of one example of a physician homepage.

FIG. 10 is an illustration of one example of a patient's information in a physician's account.

FIG. 11 is an illustration of one example of a patient's information in a physician's account.

FIG. 12 is a flow diagram illustrating when data collection occurs during pre-, peri- and post-operative phases.

FIG. 13 is an illustration of one example of how a physician can create an email to send to a patient.

FIG. 14 is an illustration of one example of how a physician can set automatic emails to be sent to patients on specific days.

FIG. 15 is a flow diagram illustrating the steps a physician can take to enter information about a patient.

FIG. 16 is a flow diagram illustrating how a physician can contact a patient after selecting percent involvement.

FIG. 17 is an illustration of one example of a patient report card.

FIG. 18 is a schematic diagram illustrating an example computing system used in accordance with one embodiment of the present invention.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

In one embodiment, the disclosed method and system can enhance patient communication and data collection through pre-, peri-, and post-operative settings. It can serve as a patient communication system that gives patients access to time-relevant and needs-specific information as the patient moves from pre-operative assessment through post-operative recovery. The system can allow database access and analysis through a HIPAA-compliant physician portal. Each procedure can be reviewable on an individual, group, or whole database level, at the discretion of the physician.

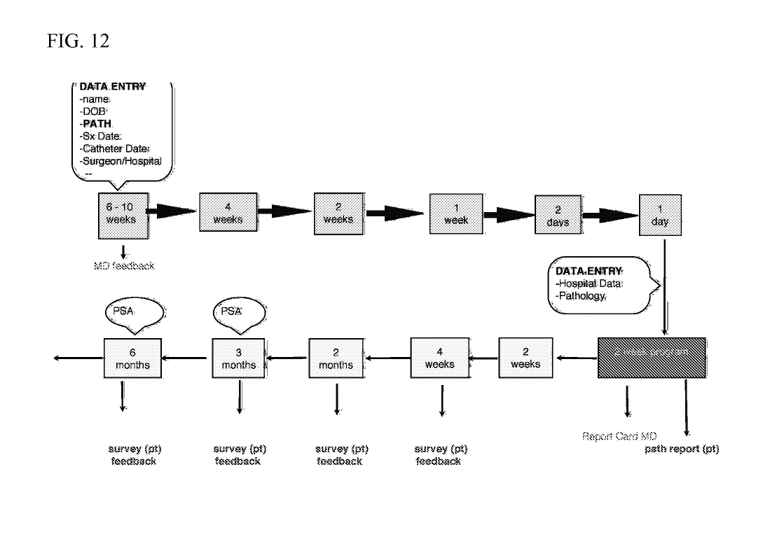

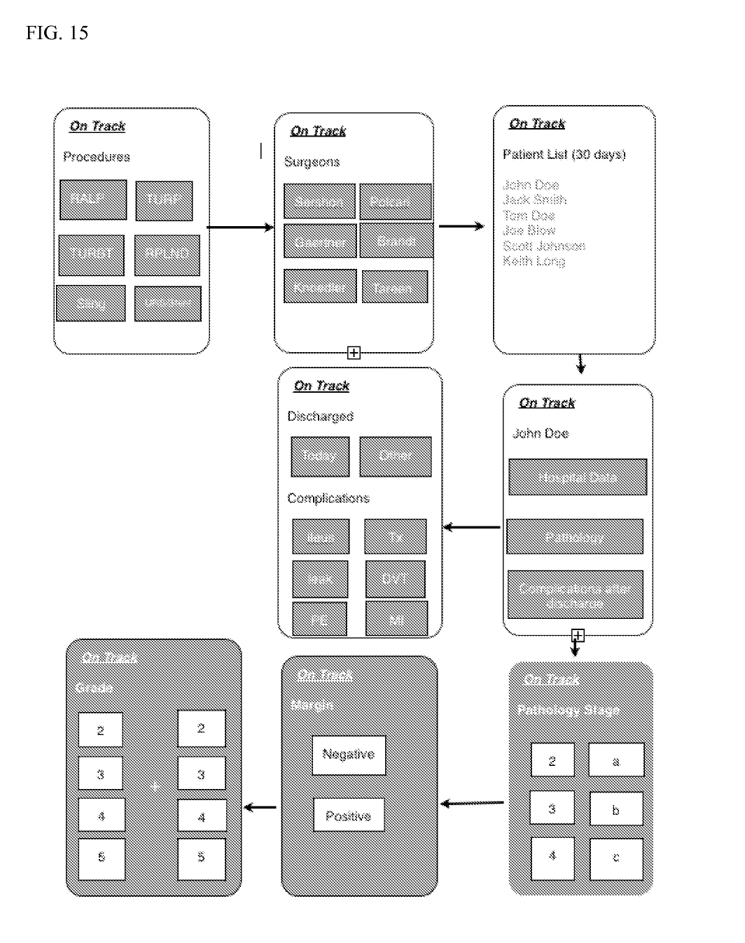

The system disclosed herein customizes patient communication for the physician group and the individual physician, guiding patients through three specific phases with each phase designed to meet unique patient communication and data collection needs. The first phase is pre-operative, which includes all events leading up to surgery. The second phase is peri-operative, which includes all events the day of surgery and any necessary, subsequent hospitalization. The third phase is post-operative, which includes all events post-hospitalization or post-office procedure, with a timeline determined by the needs of the specific operation. Data is collected at various times during each phase, as illustrated in FIGS. 12 and 15.

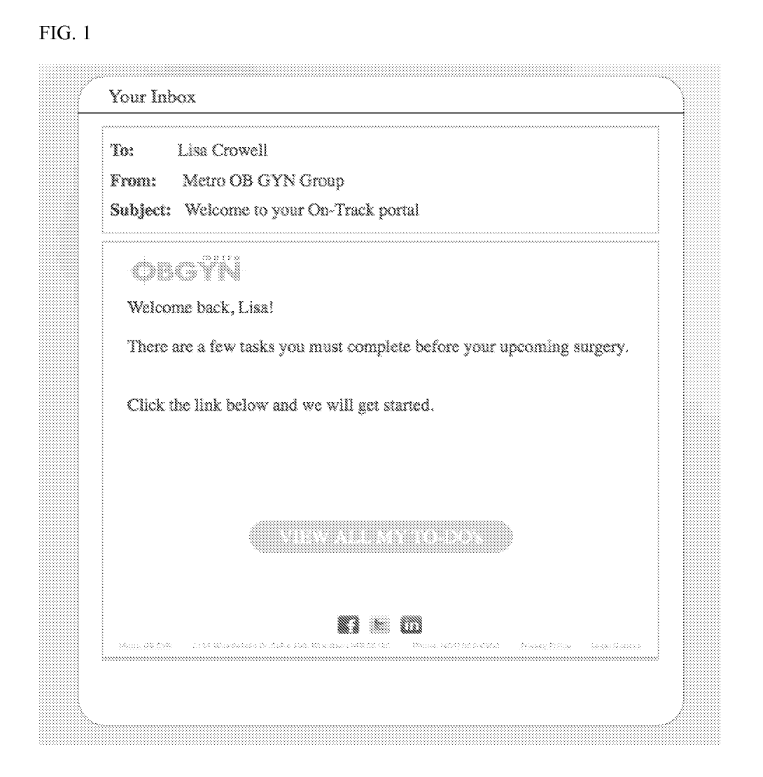

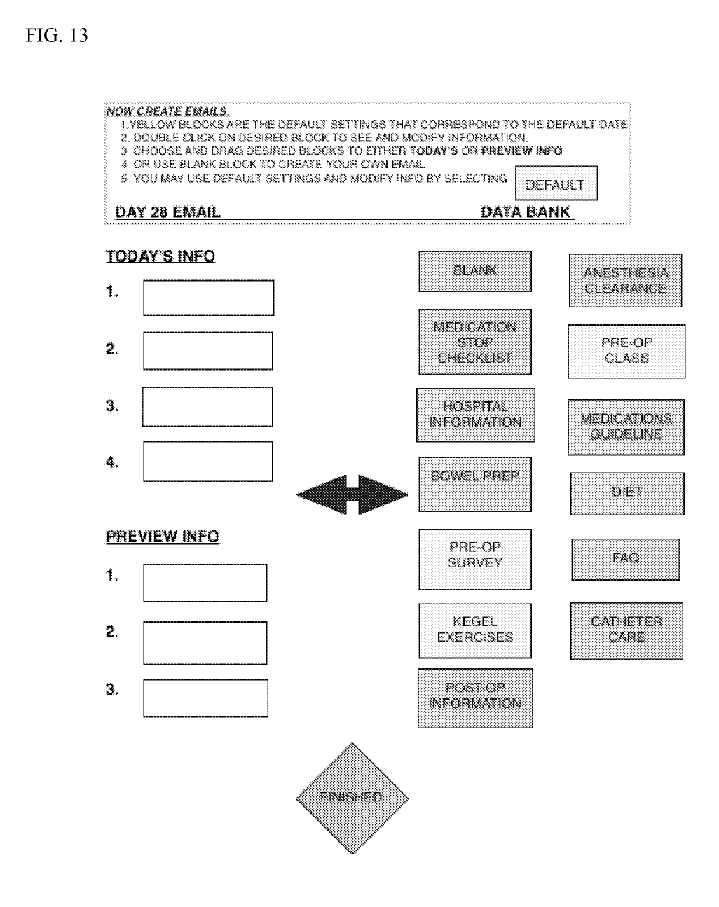

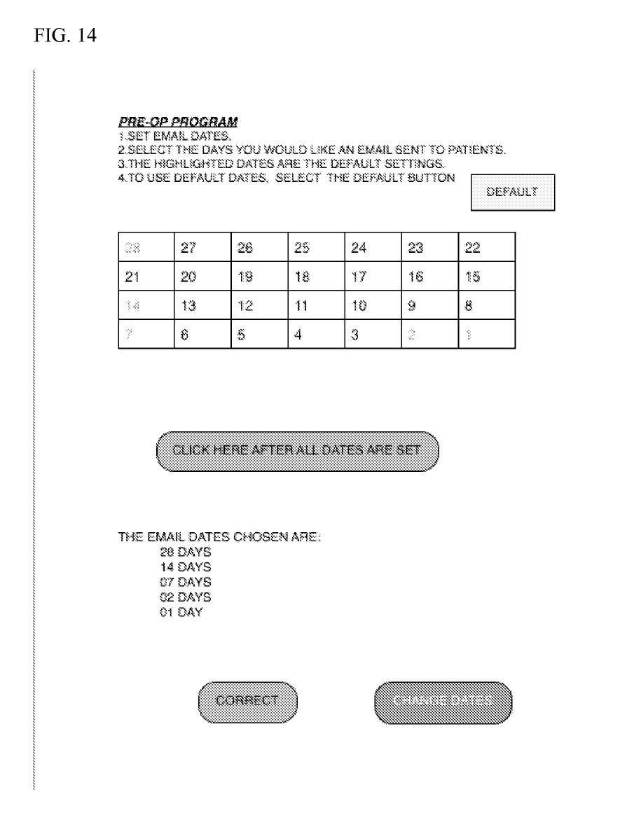

The pre-operative component of the system involves an automated timed and dated email, as illustrated in FIG. 1, that is available, at the latest, the day the patient is scheduled for surgery. The email can be customized for the particular procedure, as illustrated in FIGS. 13 and 14. Patient name, date of surgery, surgeon, procedure, surgery location, and other necessary information can be inputted into the program before surgery, usually by the scheduler. The patient can then receive timed automated emails appropriate for the particular surgery.

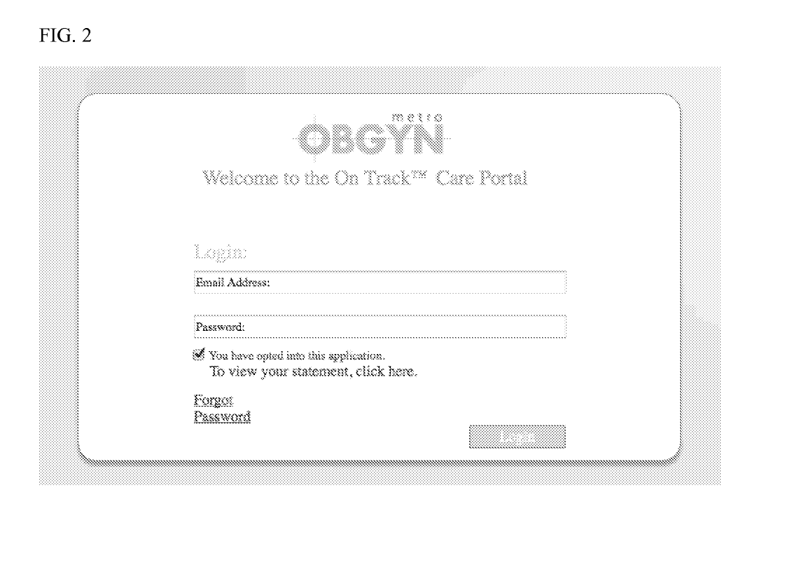

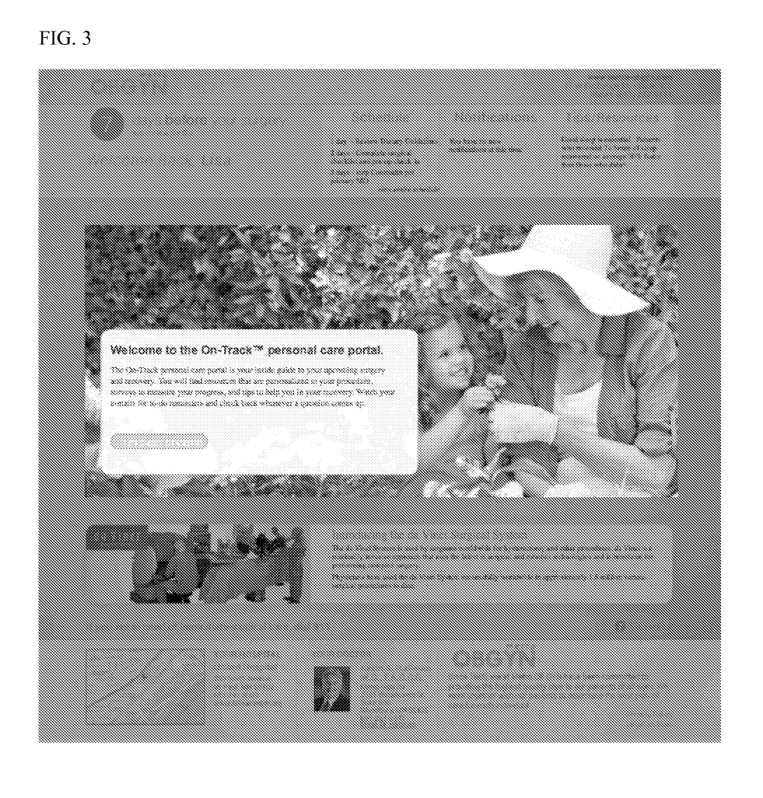

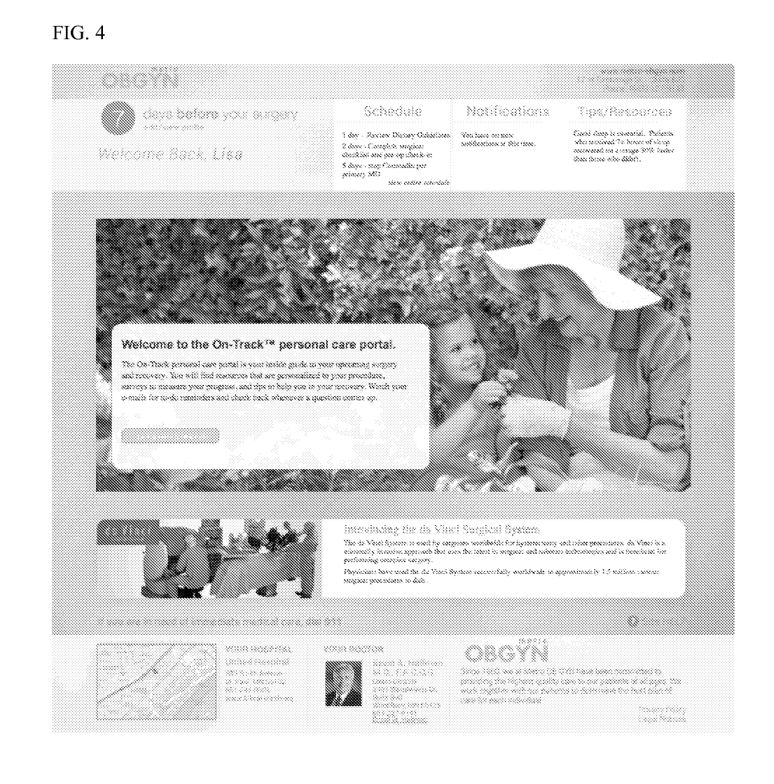

Information sent to the patient can include an appropriate, progressive, customized pre-operative checklist, as well as multimedia information and education packets that can be made specific to each physician group. The checklist can change depending on the length of time to surgery. Additionally, patients can be guided to a HIPAA-compliant portal to log in and complete procedure- and/or group-specific validated surveys and questionnaires, as illustrated in FIGS. 2, 3, and 4. If appropriate, the surgical center can also send necessary information to the patient through the system.

Notifications can be sent if patients do not open emails within a specified time period or if they do not complete pre-operative data collection. Mobile device notification, such as text messages, may be used for this purpose.

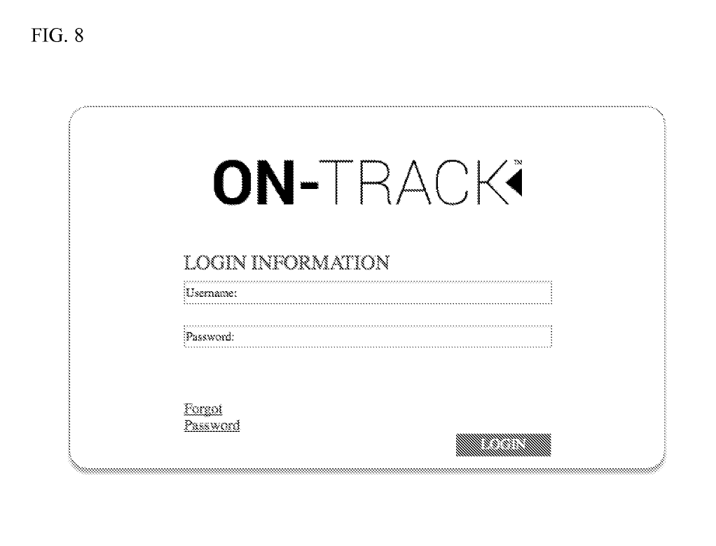

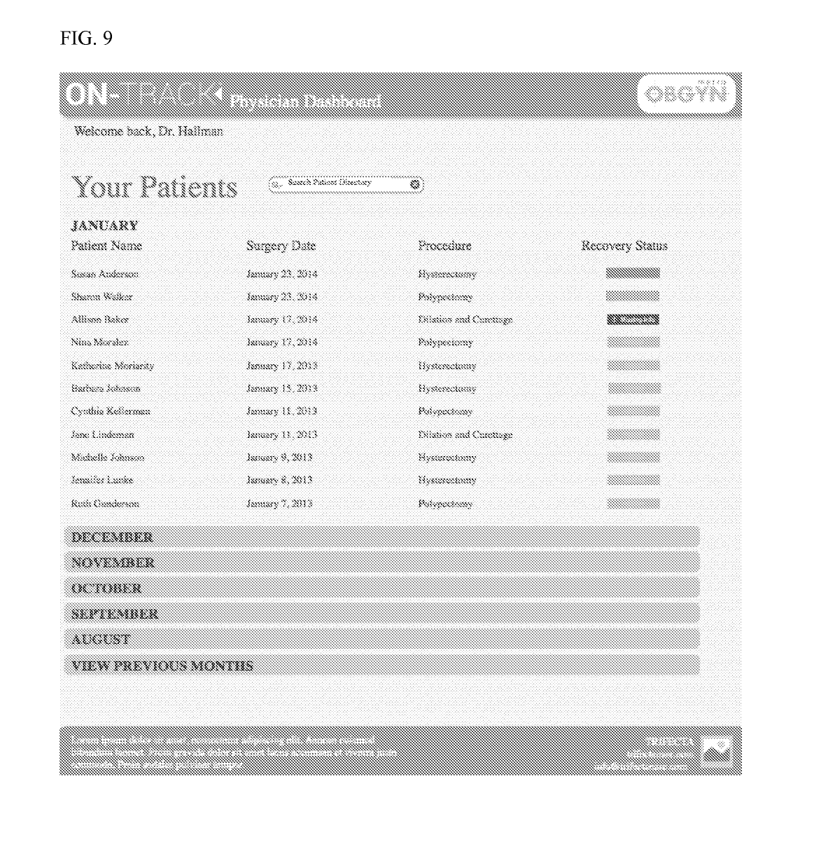

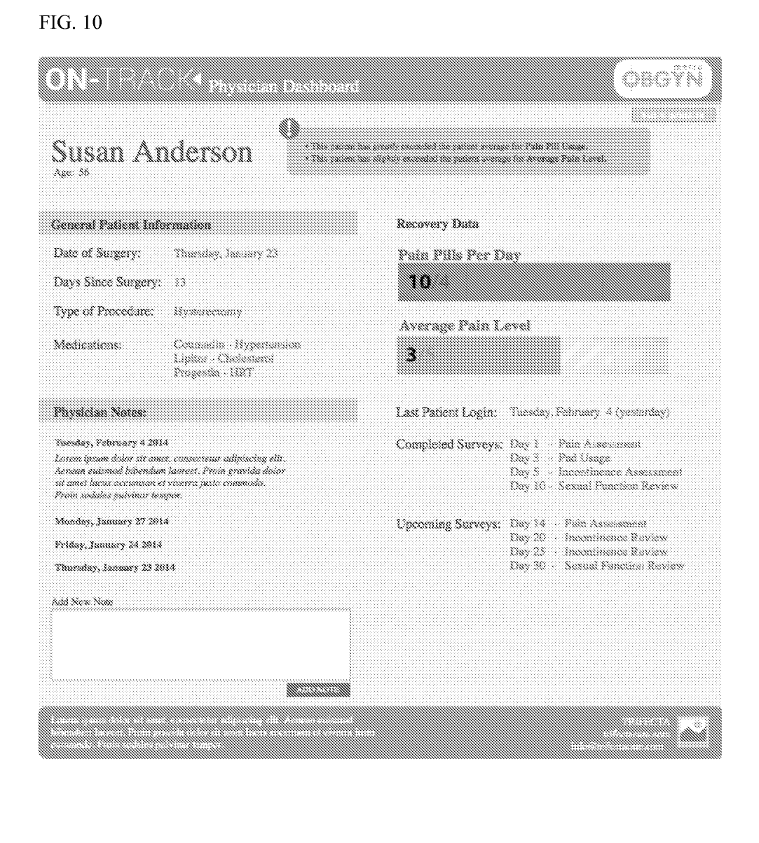

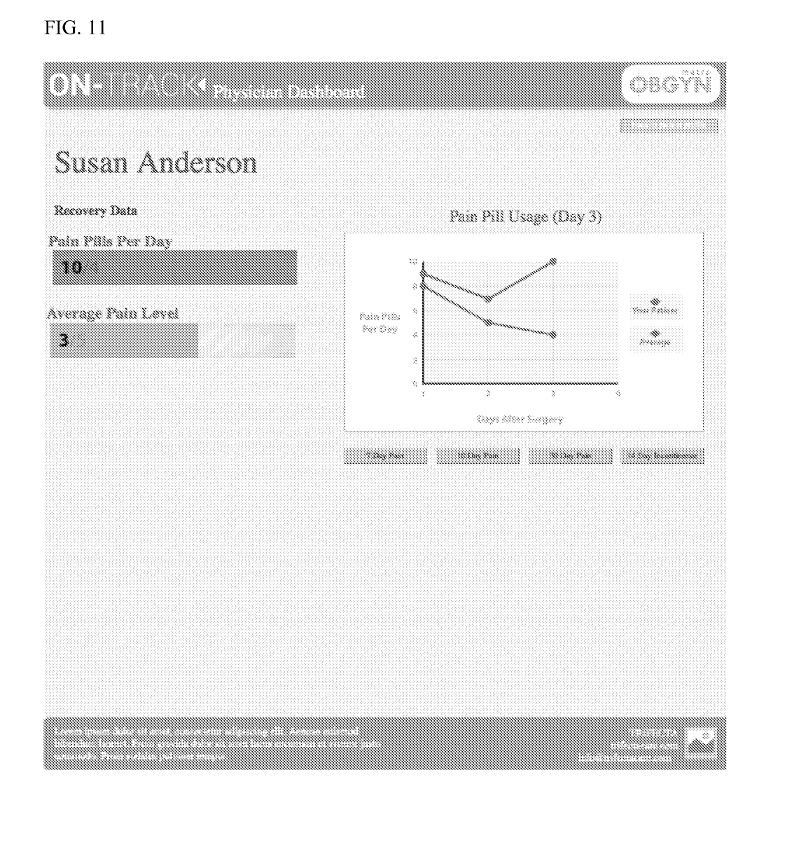

The peri-operative component of the system can collect pertinent data at the time of surgery and during any necessary hospitalization. Data collection may be done independently of, or in conjunction with, the particular surgical center. For example, a patient's surgeon can login to a HIPAA-compliant portal to track patient information, as illustrated in FIGS. 8, 9, 10, and 11. Potential peri-operative data can include, but is not limited to, patient name, data of birth, BMI, ASA status, time patient enters room, anesthesia induction, surgery start time, robot docked/undocked, surgery complete time, time the surgeon leaves the room, time the patient leaves the room, and operating room costs, such as disposable supplies. This feature allows the physician to have on the spot cost analysis and operative and turnover times records and analysis. Access to peri-operative information can lead to consistent room set-up, time and cost efficiencies, and the production of a definitive, consistent surgical card.

In addition to data collection, the peri-operative component can include a patient family notification program accessible through a mobile device. This program can allow patients' families to track inter-operative progress and review pertinent post-operative recovery information via a mobile device. Inter-operative tracking can, for example, notify family when a patient goes through each phase of surgery, such as entering the operating room, undergoing anesthesia, starting surgery, and going to the recovery room. The information can be further enhanced to include optional elements such as graphics, descriptives, and expected length of procedure. This program can be customized to the procedure or physician preference. Family can also be given access to review immediate post-operative expectations, hospital goals, home recovery instructions, and other important information.

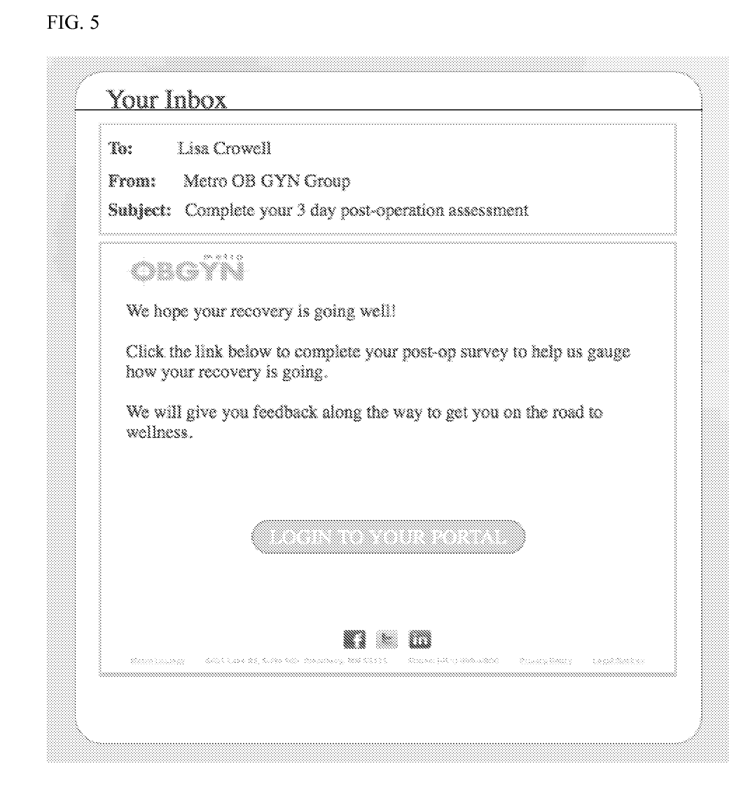

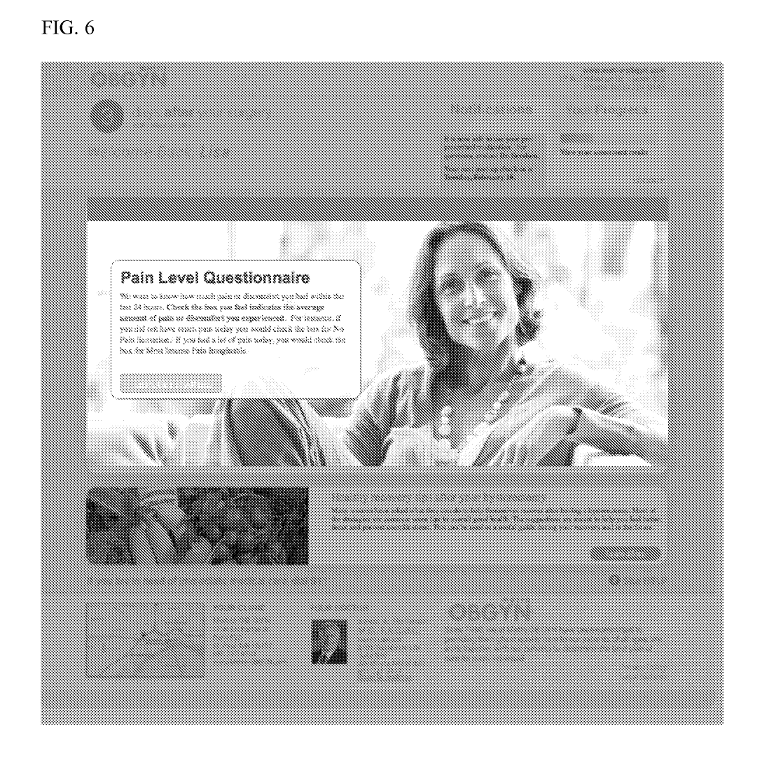

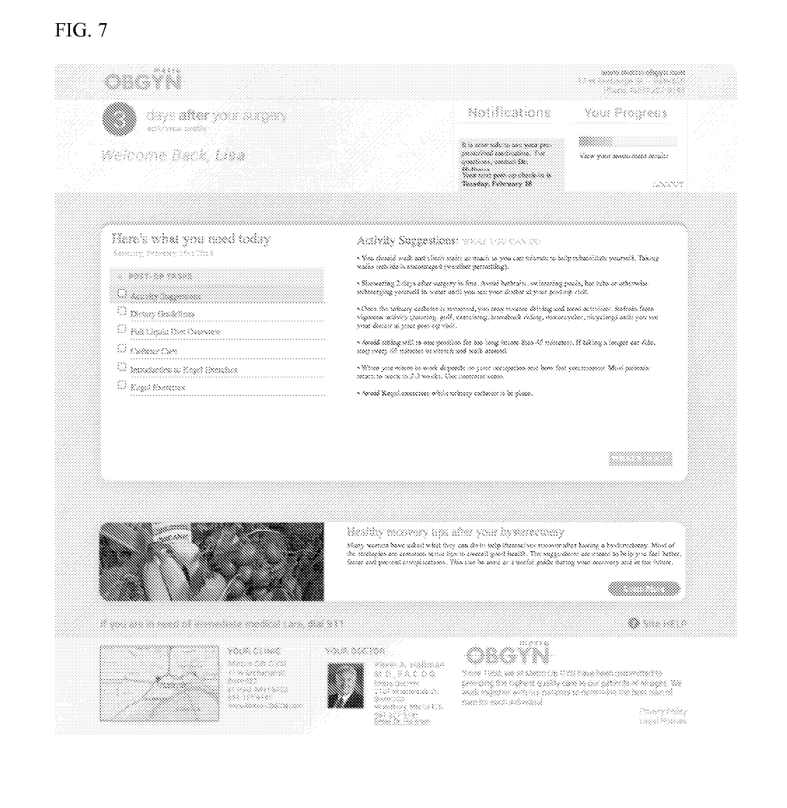

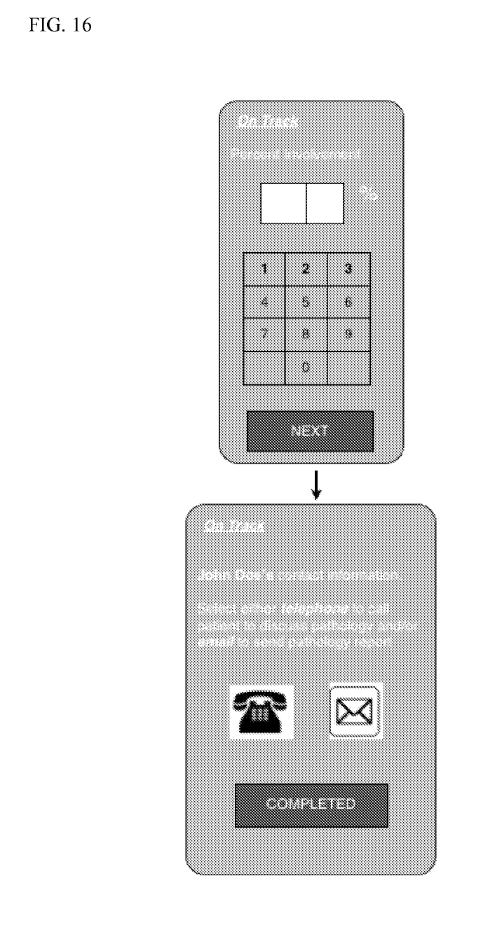

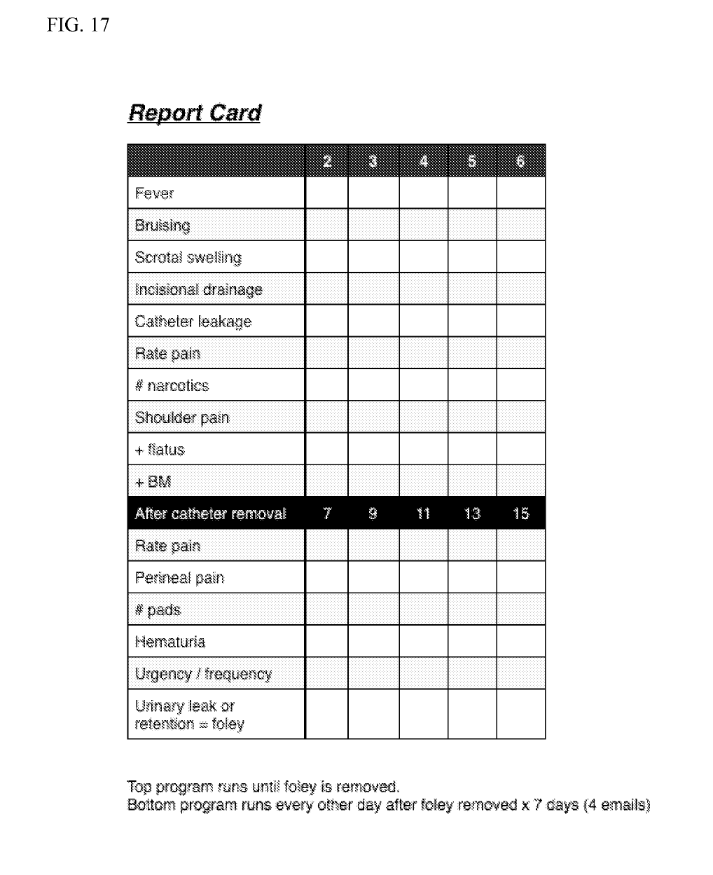

The post-operative components of the system include a time dated, automated, and customized email, as illustrated in FIG. 5, and a HIPAA-compliant portal access program, which utilizes a post-operative timeline appropriate for the specific procedure. Patients can be reminded and encouraged to access pertinent instructional and education materials and to complete surveys and questionnaires, as illustrated in FIGS. 6 and 7. Short, acute phase surveys can be used to answer common concerns and notify the patient when it is appropriate to contact the provider. If appropriate or desired, patients can track their recovery progress and compare their progress to similar patients in the database. In one embodiment, a summary report card can track patient recovery, as illustrated in FIG. 17. Validated surveys and questionnaires can collect clinical results and patient satisfaction data at appropriate times in the recovery phase of care. Further, the system permits a doctor, surgeon, or attending physician to contact patients via email or phone after an operation to discuss, for example, pathology, as illustrated in FIG. 16.

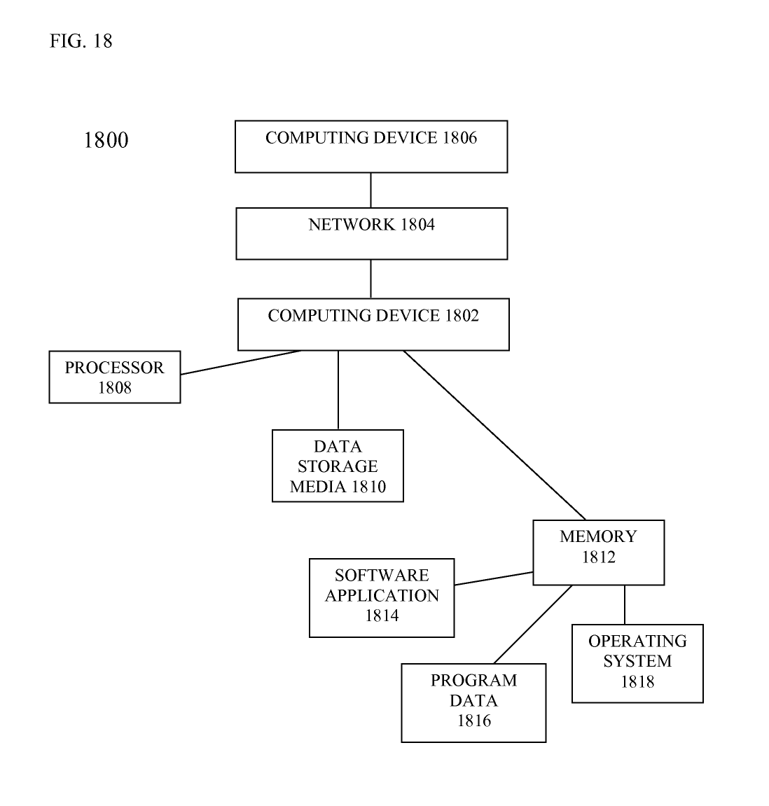

The disclosed invention involves technology that uses a computing system. FIG. 18 is a schematic block diagram of an example computing system 1800. The invention includes at least one computing device 1802. In some embodiments the computing system further includes a communication network 1804 and one or more additional computing devices 1806 (such as a server).

Computing device 1802 can be, for example, located in a hospital or healthcare facility. In some embodiments, computing device 1802 is a mobile device. Computing device 1802 can be a stand-alone computing device or a networked computing device that communicates with one or more other computing devices 1806 across a network 1804. The additional computing device(s) 1806 can be, for example, located remotely from the first computing device 1802, but configured for data communication with the first computing device 1802 across a network 1804.

In some examples, the computing devices 1802 and 1806 include at least one processor or processing unit 1808 and system memory 1812. The processor 1808 is a device configured to process a set of instructions. In some embodiments, system memory 1812 may be a component of processor 1808; in other embodiments system memory is separate from the processor. Depending on the exact configuration and type of computing device, the system memory 1812 may be volatile (such as RAM), non-volatile (such as ROM, flash memory, etc.) or some combination of the two. System memory 1812 typically includes an operating system 1818 suitable for controlling the operation of the computing device, such as the OS X operating system or the WINDOWS operating systems from Microsoft Corporation of Redmond, Wash., or a server, such as a Mac Mini with OS X or such as Windows SharePoint Server, also from Microsoft Corporation. The system memory 1812 may also include one or more software applications 1814 and may include program data 1816.

The computing device may have additional features or functionality. For example, the device may also include additional data storage devices 1810 (removable and/or non-removable) such as, for example, magnetic disks, optical disks, or tape. Computer storage media 1810 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices 1802, 1806 can be located in a hospital or healthcare facility. In other examples, the computing device can be a personal computing device that is networked to allow the user to access the present invention at a remote location, such as in a user's home, office or other location. In some embodiments, the computing device 1802 is a smart phone, tablet, laptop computer, personal digital assistant, or other mobile computing device. In some embodiments the invention is stored as data instructions for a smart phone application. A network 1804 facilitates communication between the computing device 1802 and one or more servers, such as an additional computing device 1806, that host the system. The network 1804 may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 1806 is a Web server. In this example, the first computing device 1802 includes a Web browser that communicates with the Web server to request and retrieve data. The data is then displayed to the user, such as by using a Web browser software application. In some embodiments, the various operations, methods, and functions disclosed herein are implemented by instructions stored in memory. When the processor of one or more of the computing devices 1802 and 1806 executes the instructions, the instructions cause the processor to perform one or more of the operations or methods disclosed herein. Examples of operations include patient data collection, tracking intra-operative procedures, distribution of instructional and educational materials, and other operations.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A method for managing information, communication, and data collection for a surgical patient, the method comprising:
utilizing a computing device having a processing device and a memory device and communicably coupled to at least one server through a communication network, the memory device storing instructions that, when executed by the processing device, cause the processing device to:
prior to a scheduled operation, send a patient pre-operative information based on inputted information, wherein the inputted information is selected from the group consisting of patient's name, date of surgery, surgeon, procedure, surgery location, and combinations thereof, and wherein the pre-operative information is selected from the group consisting of a pre-operative checklist, education materials, and combinations thereof;
collect perioperative data during the scheduled operation, wherein the perioperative data is selected from the group consisting of patient's name, patient's date of birth, patient's body mass index, patient's physical status, time patient enters operating room, anesthesia induction time, surgery start time, robot docked/undocked status, surgery complete time, time surgeon leaves operating room, time patient leaves operating room, operating room costs, and combinations thereof;
notify family of the patient, wherein each notification is selected from the group consisting of time patient enters operating room, anesthesia induction time, surgery start time, time patient leaves operating room; post-operative expectations, hospital goals, home recovery instructions, and combinations thereof; and
send the patient post-operative information after the scheduled operation, wherein the post-operative information is selected form the group consisting of access to a HIPAA-compliant portal that utilizes a post-operative timeline for the patient, education materials, surveys, a summary report card, and combinations thereof.
